(19) United States
(12) Patent Application Publication
(10) Pub. No.: US 2004/0078303 A1
(43) Pub. Date: Apr. 22, 2004

(54) Method of providing a product line of doors

(76) Inventor: Daniel E. Patridge, Stratford, WI (US)

Correspondence Address: Michaele A. Hakamaki, KAGAN BINDER, PLLC, Maple Island Building, Suite 200, 221 Main Street North, Stillwater, MN, 55082, US

(21) Appl. No.: 10/614,912

(22) Filed: Jul. 8, 2003

Related U.S. Application Data
(60) Provisional application No. 60/394,717, filed on Jul. 8, 2002.

(51) Int. Cl. G06F 17/60

(52) U.S. Cl. 705/27

(57) ABSTRACT

A method of providing a product line comprising a plurality of doors, wherein each door comprises at least one working surface, the method comprising the steps of providing a product line of doors having at least one customer-selectable option, wherein the at least one option includes a feature of one of the working surfaces, and receiving an order comprising a selection of at least one door of the product line of doors, wherein the order includes selection of at least one door and a selection of at least one option for the working surface.

### CROSS REFERENCE TO RELATED APPLICATION

This application claims the benefit of U.S. Provisional Application Serial No. 60/394,717, filed Jul. 8, 2002, entitled “A METHOD OF PROVIDING A PRODUCT LINE OF DOORS,” which application is incorporated herein by reference in its entirety.

### TECHNICAL FIELD

The present invention relates a product line of working surfaces installed into or onto the surface of a door, providing a new vehicle or mode to communicate.

### BACKGROUND

In typical room arrangements, such as in offices or conference rooms, markerboards, corkboards, chalkboards, etc. are usually installed on the walls of rooms, which can be undesirable when the wall space is limited and/or when the wall structure cannot support the weight of a working surface. Alternatively, it is known for a user to attach a self-supporting working surface to a flat vertical surface, such as a wall or door surface. The present invention is unique in that in the preferred method, the working surface can be built right into the face of the door and act as part of the door. The preferred embodiment of the working surface door thus allows a cleaner look by giving the option of installing these working surfaces directly into the face of a door. In addition, it is desirable to provide a method for users to be able to select and order doors having a variety of optional features, where such doors can be selected from a particular product line of doors.

### SUMMARY OF THE INVENTION

The present invention is directed to a method of providing a product line comprising a plurality of doors, wherein each door comprises at least one working surface, the method comprising the steps of providing a product line of doors having at least one customer-selectable option, wherein the at least one option includes a feature of one of the working surfaces, and receiving an order comprising a selection of at least one door of the product line of doors, wherein the order includes selection of at least one door and a selection of at least one option for the working surface. The method may further comprise the step of manufacturing the at least one door after receiving the order. The customer-selectable option may include at least one of a set of available sizes for the working surface, a set of available surface materials for the working surface, a set of available shapes for the working surface, or a set of available mounting configurations for the working surface. The method may also include the step of making marketing information available to customers, wherein the marketing information comprises a set of available working surface options.

The present invention is also directed to a product line of doors comprising a set of doors and a cooperative set of working surface panels, wherein each door has a surface for receiving at least one of the panels of the set of working surface panels. The present invention is also directed to a method of marketing a product line comprising a plurality of doors having at least one working surface, the method comprising the steps of providing a product line of doors to a customer, wherein the product line includes at least two working surface panels and at least one door, and receiving an order comprising a selection of at least one door of the product line of doors, wherein the order includes a selection of at least one working surface panel. The present invention is also directed to a product line comprising a plurality of doors, each door fitted with one or more working surfaces, the working surfaces being available in multiple configurations such that a customer has an option of selecting at least one door of the product line with a desired working surface configuration. This method may further include the step of marketing the product line.

### BRIEF DESCRIPTION OF THE DRAWINGS

The present invention will be further explained with reference to the appeneded figures, wherein like structure is referred to by like numerals throughout the several figures, and wherein:

FIG. 1 is a perspective view of a door assembly in accordance with the present invention;

FIG. 2 is a cross-sectional view of a door assembly of the present invention, including a molding fastener;

FIG. 3 is a cross-sectional view of another door assembly of the invention;

FIG. 4 is a cross-sectional view of one embodiment of a molding for use with doors in accordance with the invention;

FIG. 5 is a cross-sectional view of another door assembly of the invention;

FIG. 6 is a cross-sectional view of another door assembly of the invention;

FIG. 7 is a partial cross-sectional view of another door assembly of the invention;

FIG. 8 is a cross-sectional view of another door assembly of the invention;

FIG. 9 is a cross-sectional view of another door assembly of the invention;

FIG. 10 is a cross-sectional view of one embodiment of a molding for use with doors in accordance with the invention;

FIG. 11 is a front view of a door having two panels in accordance with the invention;

FIG. 12 is a cross-sectional view of one embodiment of a molding for use with doors in accordance with the invention;

FIG. 13a is a front view of a portion of a door assembly including a working surface and an accessory portion, with the accessory portion also illustrated as a side view;

FIG. 13b is a front view of a portion of another door assembly including a working surface and an accessory portion, with the accessory portion also illustrated as a side view;

FIG. 14 is a cross-sectional view of a tray or accessory piece used with the doors of the present invention;

FIG. 15 is a cross-sectional view of another tray or accessory piece used with the doors of the present invention;

FIGS. 16a and 16b are top views of a two-page specification sheet for a product line of the present invention; and

FIG. 17 is a top view of a piece of marketing literature available for a product line of the present invention.

### DETAILED DESCRIPTION OF THE PREFERRED EMBODIMENTS

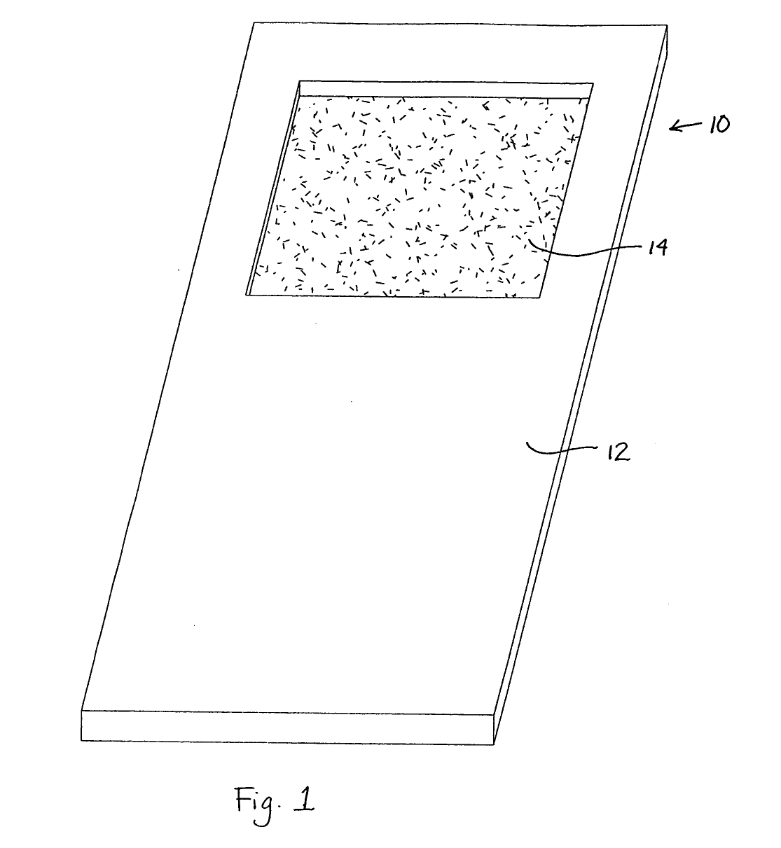

Referring now to the figures, FIG. 1 illustrates a door assembly 10 including a door panel 12 having a recessed area 14 in accordance with one embodiment of the present invention. The recessed area 14 of the door panel 12 is preferably sized to accept a working surface (also referred to herein as a “workable surface”) and typically involves installing a working surface in the recessed area, including, but not limited to, a white board or markerboard, corkboard, pushpin board, chalkboard, or mirror. Other examples of working surfaces that may be used include computer monitors, pressure sensitive touch screens, light elements for interior design aesthetics and illumination, and signage/logos (electronic or other).

It is understood that any dimensions and relative component sizes shown in the figures are only intended to be representative, therefore, the door dimensions, including components, can be chosen appropriately, depending on the particular desired door configuration.

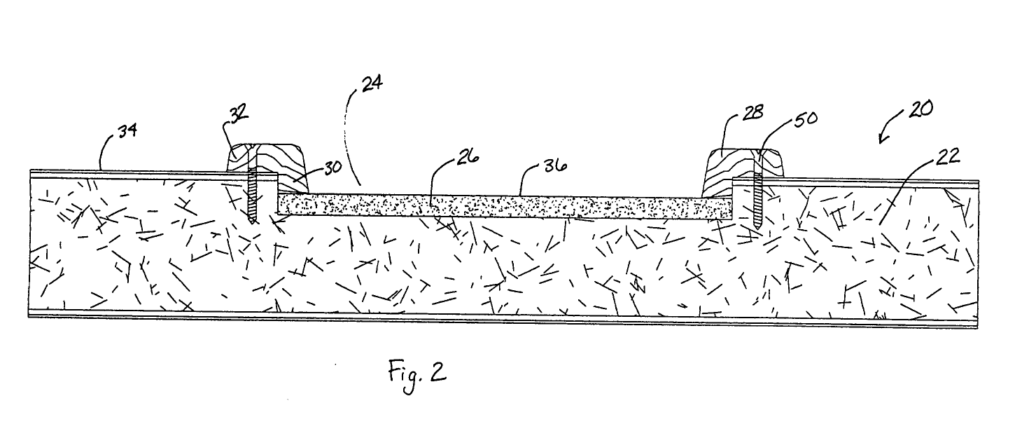

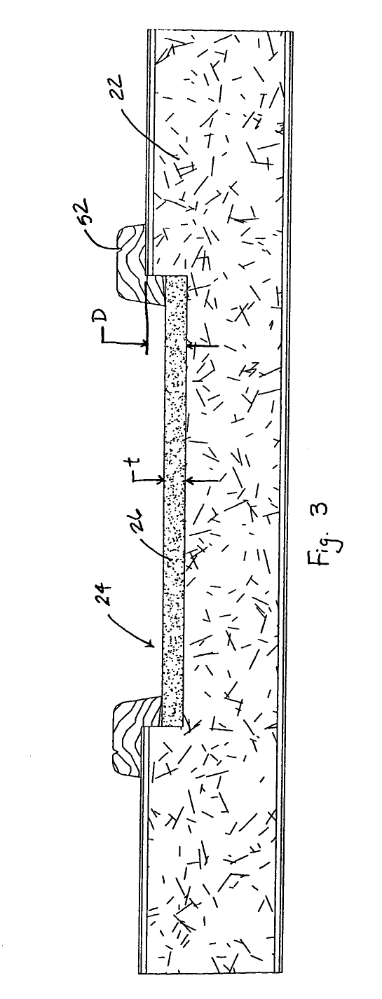

In one preferred construction, a working surface is installed such that it is inset into the recessed area in the face of the door. Cross-sectional views of this type of embodiment, including individual components, are shown in FIGS. 2, 3, 5-7, and 9. In particular, FIG. 2 illustrates a door assembly 20 including a door panel 22 having a recessed area 24 and a working surface 26 within the recessed area 24. To manufacture this construction, a profile of the desired working surface shape is routed into the face of a solid core door panel (such as panel 22) so that the profile is deeper than the thickness of the working surface 26 to be installed therein. In particular, the depth D of the recessed area 24 is preferably greater than the thickness t of the working surface 26, as best illustrated in FIG. 3. In addition, the working surface 26 is cut to be equal to or slightly smaller than the size of the profiled or recessed area or opening 24, and is then set into the opening 24. Depending on the type of working surface being installed, it may be desirable to use an adhesive or other attaching method on the back of the working surface to insure it lays flat on the attachment surface of the door. In addition, if a profile is routed into the face of the door, it may be necessary to apply a sealer, gasketing or other type of barrier between the working surface and the recessed area to prevent moisture or debris from affecting the integrity of the door. While the shape of this recessed area 24 and working surface 26 are shown as generally rectangular, any desired shape may be chosen.

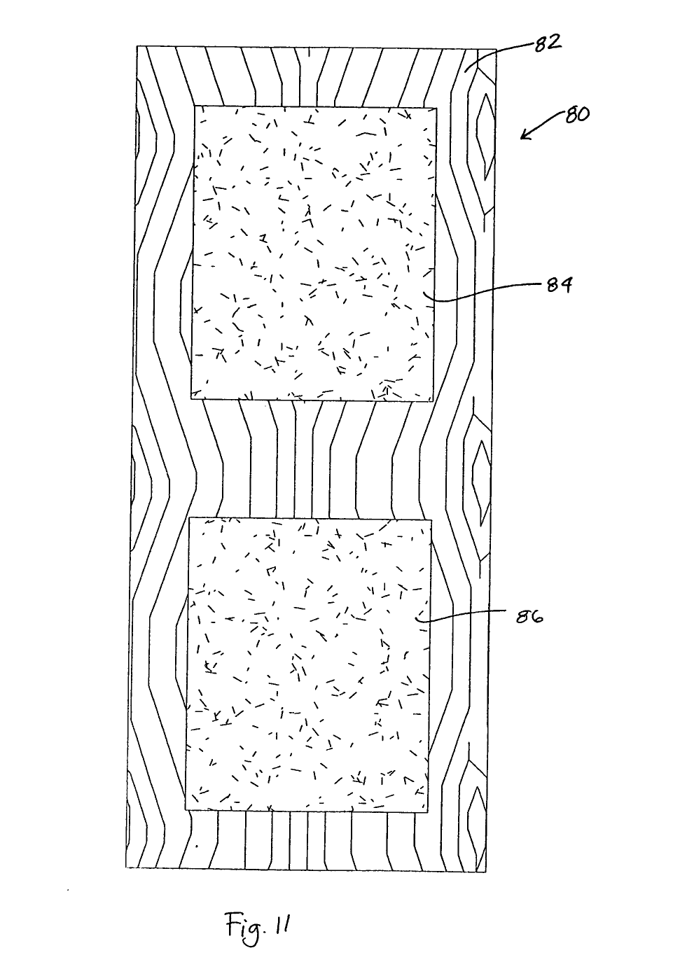

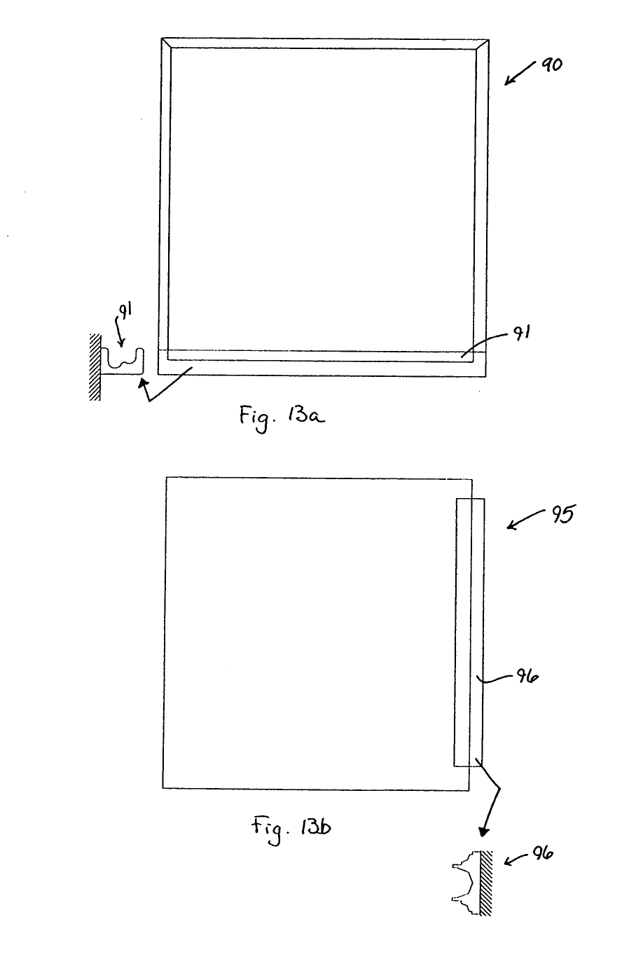

Using the preferred method, one or more molding pieces 28 are then placed around the perimeter of the opening. The molding 28 is preferably “lipped,” so that it extends partially onto the working surface 26 and partially onto the face of the door panel 22. One leg 30 of the molding 28 extends into the profiled or recessed area 24, and rests on the working surface 26 which is inset into the face of the door panel 22, while the other leg 32 of the lipped molding 28 fits onto the non-profiled face 34 of the door panel 22. Using alternate attachment methods will require a different design of molding be used. For example, the top face 36 of the working surface 26 may alternatively be installed such that it is flush with the door face 34 and so that the bottom of the molding is generally flush as well (i.e., no leg portion extends below the portion 32 that contacts door face 34). The bottom of the molding may also have a relief or indentation in the surface that contacts the door to provide a receiving area for an adhesive for attaching the molding to the door. A plastic partition connector, such as that used in bathrooms to hold panels together, may also be used in this configuration. For another example, the workable surface may be installed such that it rises above the plane of the door face 34, and a lipped molding can then be used. An example of such a molding 40 is illustrated in FIG. 10. In this configuration, the shorter portion 42 of the lipped molding will hold the workable surface in place, while the longer portion 44 of the lipped molding 40 will lie against the face of the door. This molding 40 further includes an optional chamfer or angled surface 46 which only partially comes in contact with a workable surface. For example, only the contact tip 48 of the molding may contact the workable surface, or the tip 48 and a portion of the surface 46 may contact the workable surface. An example of another profile of a molding 43 is illustrated in FIG. 12. Any of the provided moldings may also have an optional chamfer or angle provided on at least one of the surfaces that is designed to contact the working surface so that the contact tip of the molding can provide a tight or solid connection between the molding and the working surface.

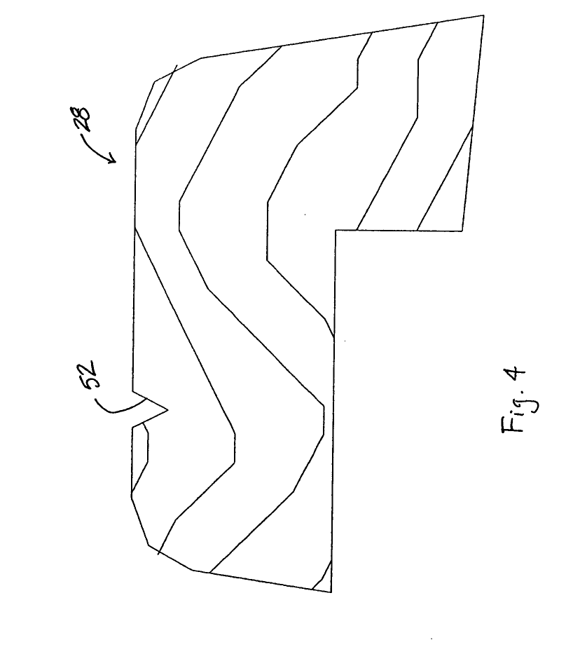

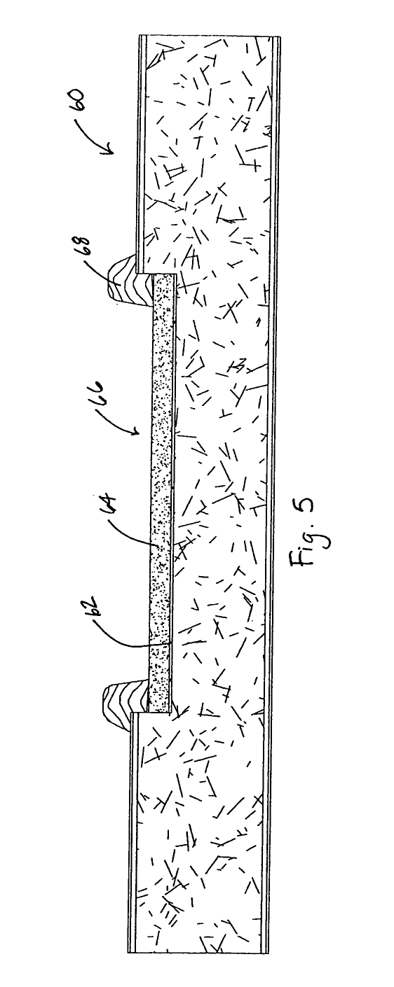

In the preferred embodiment, wood screws 50 (as shown in FIG. 2) are then installed at intervals around the molding 28 to hold the working surface 26 securely to the door panel 22. Other means such as nails, two-sided tape, glue, caulk, etc., may also be used to hold the frame or molding securely in place around the workable surface as long as they are easily removable and replaceable. If mechanical fasteners such as screws or nails are used to hold the molding in place, the preferred embodiment should be fastened through the molding into the door perpendicular to the uncut, flush face of the door (such as surface 34). Preferably, the fasteners should not extend through or into any part of the working surface. Optional grooves or locator channels 52 may be cut into the molding to assist in properly locating the fasteners relative to the door and the working surface, as illustrated in FIGS. 3 and 4, for example. The groove may extend around the entire perimeter of the molding, may be provided only in certain or discrete locations, or may be omitted entirely, as is illustrated in FIG. 5. In this embodiment, door panel 60 includes a relatively thin layer 62 of glue or caulk to secure a working surface 64 within a recess 66. Molding 68 does not include a groove, as described above.

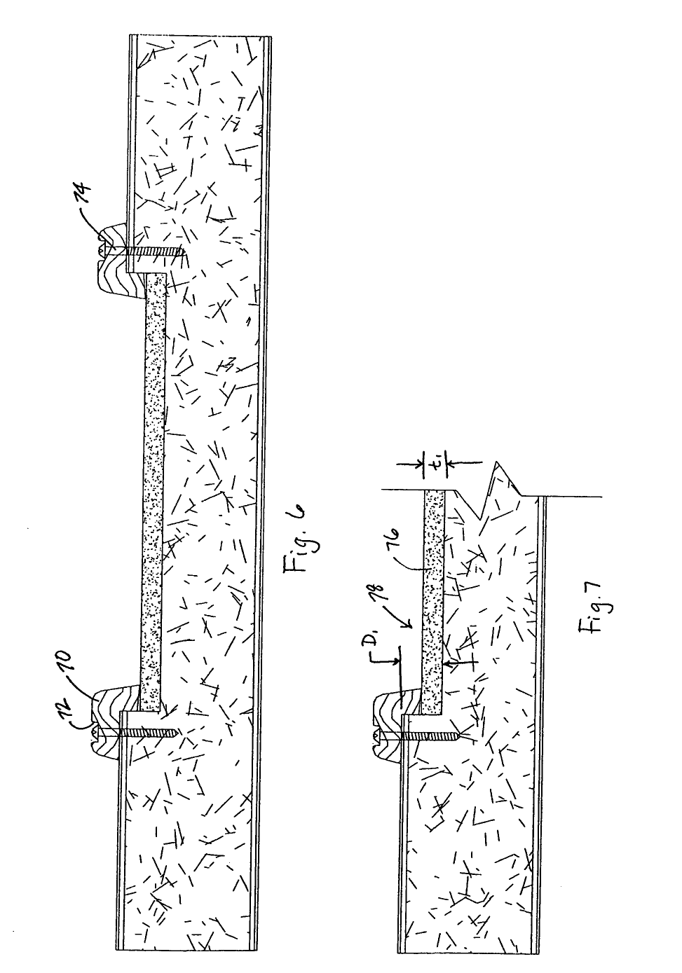

FIGS. 6 and 7 show a molding 70 with generally U-shaped grooves 72 for accepting other types of fasteners 74, such as flat head screws. Further, FIG. 7 illustrates a thickness t₁ of an exemplary working surface 76 that is approximately 0.25 inches thick and an exemplary recessed area 78 having a depth D₁ of approximately 0.50 inches. These dimensions can vary widely, depending on the particular door construction desired. It is understood that any appropriate locating method may be used for properly positioning and securing the molding relative to the door and working surface.

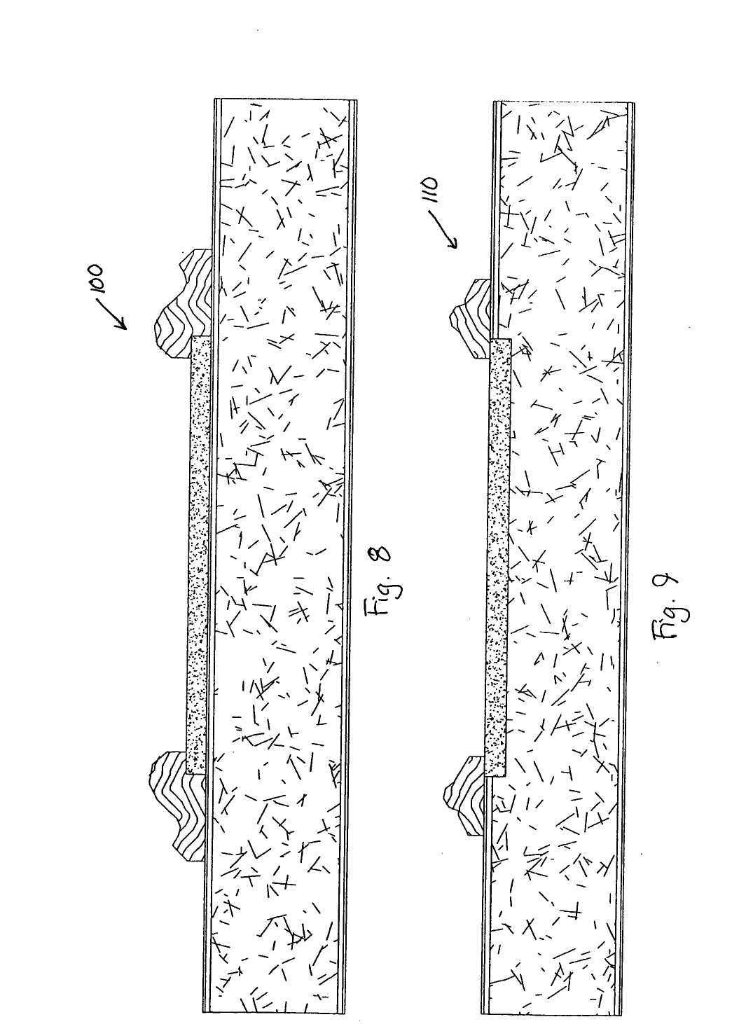

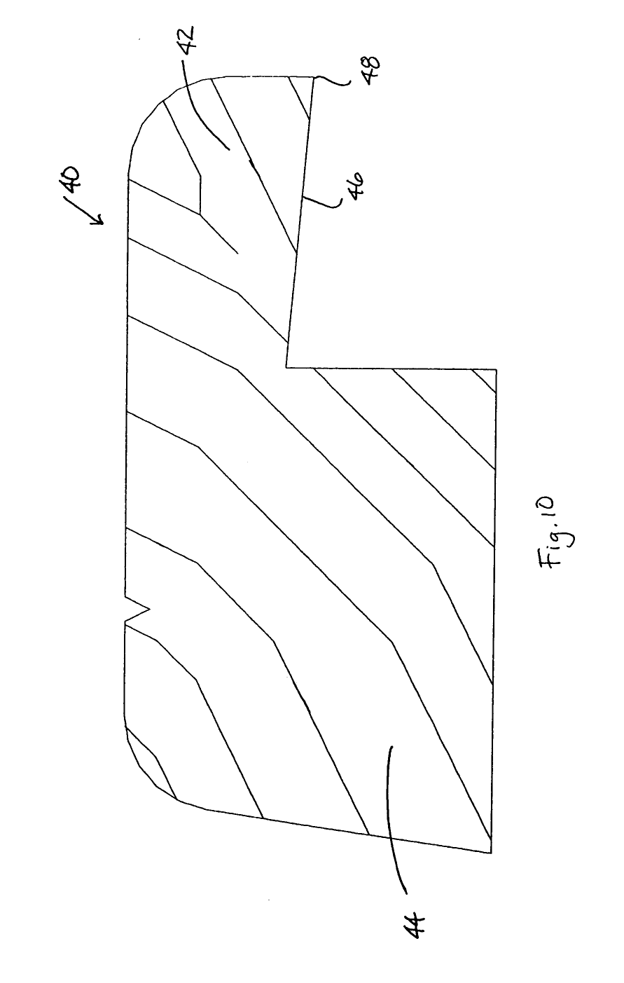

Alternate constructions of the present invention include profiling the same depth into the door as the thickness of the working surface, as shown as assembly 100 in FIG. 8, profiling less than the thickness of the working surface, or not profiling at all into the face of the door, as shown as assembly 110 in FIG. 9. Using one of the alternate methods involving profiling will still preferably include a working surface cut to be equal to or slightly smaller than the size of the opening. If no profiling is done, the working surface may be cut to any size which will fit onto the surface of the door.

While the preferred construction describes the door as a solid core door, many other types of door constructions are considered to be within the scope of the present invention. For example, other acceptable door core types could include hollow, honeycomb, wafer filled, insulated, solid particle core, Laminated Strand Lumber (LSL) or Strand Core Lumber (SCL), stave, Medium Density Fiberboard (MDF) board, mineral/fireproof and combinations of any of these or other door types.

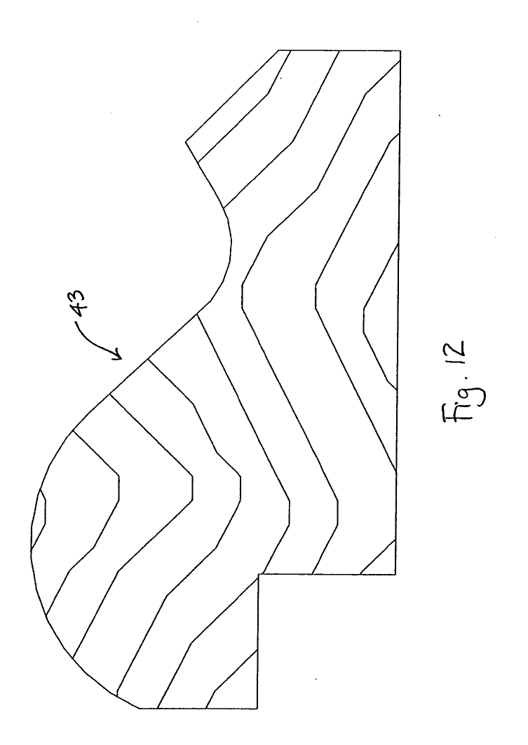

The working surfaces of the present invention are advantageous in that they can be installed either inset into the face of a door, flush with the face of a door, or onto the face of a door. The working surface may also be installed in multiple locations on one or both sides of the door. One example of a door assembly 80 including a door panel 82 with two recessed areas 84, 86 is illustrated in FIG. 11. The various embodiments and scope of the present invention may also be extended to fire-rated doors.

Over time, if a working surface gets damaged or if the customer wishes to use a new or different working surface in their door, they may simply remove the fasteners from around the molding, take out the old working surface, replace it with the desired new working surface, and reinstall the same molding or install a different molding.

In another embodiment of the invention, the working surface may not require replaceability, thereby allowing the use of permanent adhesives for attachment.

While a consumer may currently purchase various working surfaces (at office supply stores, for example) for attachment to the surface of an existing door, the door system of the present invention is advantageous for many reasons, several of which are set out as follows:

1. A working surface purchased at an office supply store is typically installed onto the face of the door because installing the working surface inset into the face of an existing or standard door would require a great deal of hand routering.

2. Inset working surfaces are more aesthetically pleasing.

3. The fact that the working surface of the present invention is built into the door gives it a cleaner look, and helps give the room in which it is installed a neater appearance. Working surfaces are often mounted on walls around the room, and that need may be minimized with the present invention.

4. The molding around a working surface purchased at an office supply store will most likely not be custom finished (both wood specie and stain color) to match the face of a wood faced door. Wood molding may not even be readily available.

5. Plastic, MDF, or other types of molding could also be used in the present invention.

6. The working surfaces of the present invention can be offered in a variety of convenient sizes, which would strategically fit into or onto various common sizes of doors. The working surfaces available in an office supply store are generally not readily available in these convenient sizes, or in a wide range of sizes.

7. The working surfaces may be provided in several designer colors, allowing the door to act as multifunctional designer tool. The working surface color may be chosen to match aspects of the room, such as wallpaper or carpeting, while still allowing the rich warmth of a wood door which may match other furniture in the room such as desks or cabinets.

8. The working surface of the present invention may also be fabric covered in any number of colors, patterns, designs, etc.

9. A working surface purchased from an office supply store may easily become detached from the face of a door during normal door use, depending on the fastening method, as these working surfaces are generally designed to be installed on a stationary wall. Insuring the surface will not become dislodged due to normal use may require the use of additional fasteners (screws, nails, etc) which may be visually unappealing. The working surfaces of the present invention, when installed in the preferred manner, are held securely in place on the door by strategically positioned fasteners located around the lipped molding.

10. If a working surface purchased from an office supply store wears out, such as a framed white board, for example, the customer must remove the entire assembly (frame and surface) and replace it with an entire new assembly. The working surfaces of the present invention allow easy removal of the decorative wood screws around the molding at the perimeter of the working surface. The molding can be reused, and a new surface may be installed. The new surface may be the same as the old, or can be a different surface.

11. The working surface (e.g., markerboard or corkboard) purchased at an office supply store may be of a lower quality than those that can be offered with the door systems of the present invention.

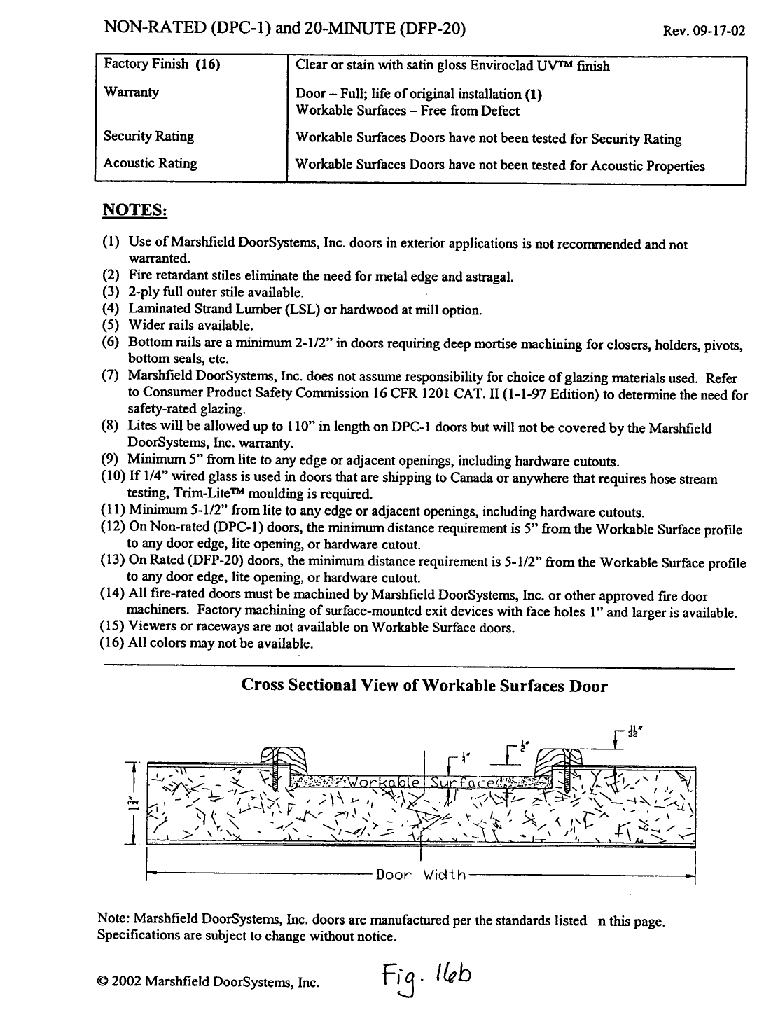

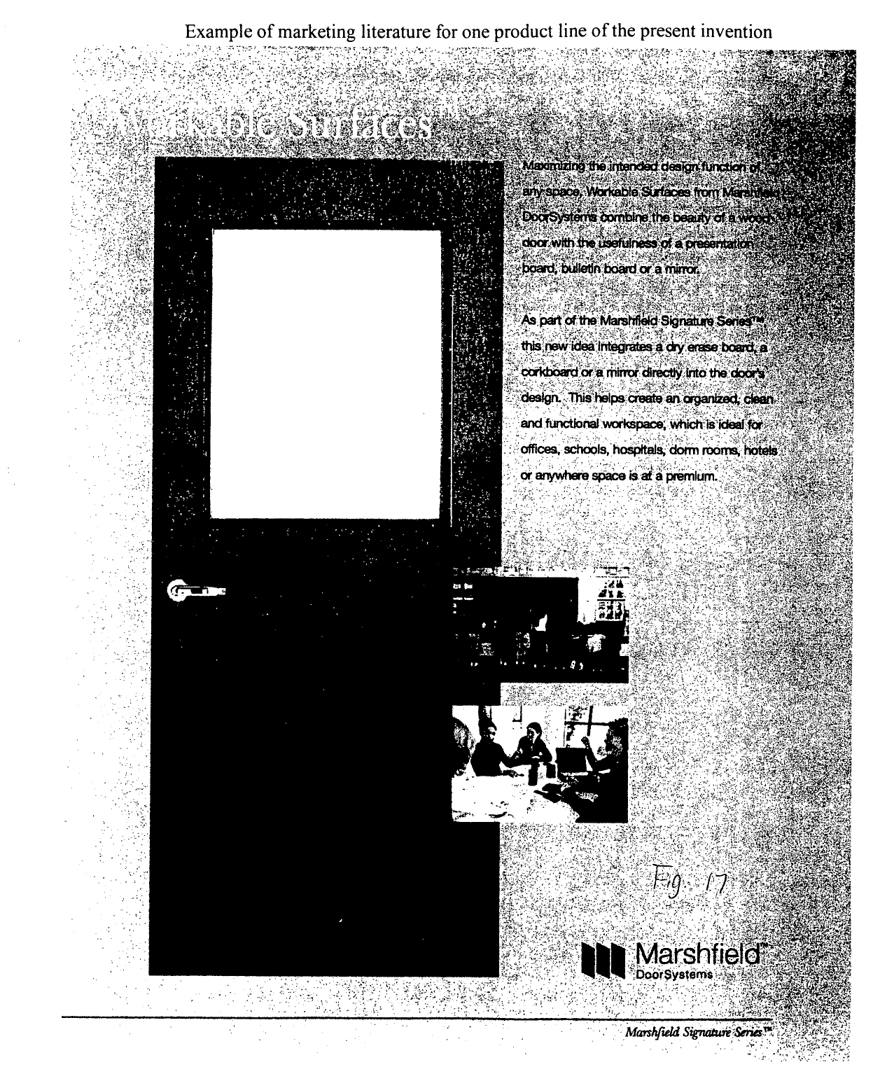

In the present invention, a customer who is ordering a new door or group of doors will preferably be provided with marketing literature (either by paper, electronically, or otherwise) containing a product line of doors. This product line preferably will include a choice of several options for working surfaces to be installed in or on each door. In particular, the consumer would preferably be provided with a choice of several sizes and types of working surfaces and may additionally have other choices related to various shapes, colors, textures, and the like. The customer would then simply select the particular working surface they wish to have installed in or on a particular door they have chosen from the product line, and place their order. The product line would preferably also include a group of available replacement working surfaces so that the consumer would be able to replace the original working surface they received with the door, as desired. FIGS. 16a and 16b illustrate one example of a two-page specification sheet for a product line of the present invention. FIG. 17 illustrates one example of a piece of marketing literature available for a product line of the present invention.

Again, in the preferred method of the invention an architectural solid core door will be used. The following description pertains to the assembly and manufacturing of one preferred door embodiment.

1. Manufacture a solid core architectural wood door. The door will preferably consist of a solid core of particleboard, laminated strand lumber, stave core, mineral core, or other typical core types. The door will preferably have stiles and rails secured to each side of the core, and either skins, veneers, high pressure laminates, hardboard, and other types of faces found on architectural wood doors glued and pressed onto each side of the core.

2. After the door is constructed, it may be machined for the working surface insert. If any part of the insert is to lie below the plane of the door face, a cut must be made into the face of the door in the general size and shape of the surface to be inserted. In the preferred embodiment, the profile will extend ½″+/−⅛″ into the face of the door. Alternative methods of installing a working surface could be to pre-machine the profile and then lay up the veneer around it, or to construct a “stile and rail” type door, but use a working surface as one or more of the panels on one or both sides of the door.

3. The workable surface may also be installed as an insert into a Shake Style or Rail & Stile Type Door as one of the panels on one or both door faces. The workable surface may also be a composite panel with a standard opposing side wood panel maintaining the standard aesthetics of the door on one side.

4. After the profile is cut (if necessary), the door may be sanded and finished as required. The working surface may then be installed into or onto the door. This entails:

a) Doing any touch-up work on the profiled cutout. For example, depending on the capabilities of the profiling equipment and the desired shape of the working surface area, the corners of the profile may need to be squared out (if a square or rectangular recessed area is desired).

b) Cutting the working surface itself so that it fits properly into the opening (if the door is getting a working surface requiring profiling into the face).

c) Applying a small amount of adhesive to the back of working surfaces or door recess, which may require it. For example:

(1) Unbacked cork working surfaces should have either a small amount of adhesive or two sided tape between their back surfaces and the recessed area surface. This will ensure the cork will not pick up, cup or bubble at any location.

(2) Mirrored glass working surfaces should have a suitable type and quantity of mirror mastic or other suitable adhesive holding them in place, to prevent damage occurring to the mirror due to normal door use (e.g., reduces the vibrations/shock to the mirror).

Working surfaces that are rigid on their own or include a rigid backing material on them may not require any sort of adhesive be used between the back (non-working) side of the material and the surface of the door.

d) Fitting a framework of molding around the working surface. The frame may be either pre-assembled or cut and assembled at the time of installation. The frame should sit tightly against the working surface. In the preferred method, any gap present between the outside perimeter of the working surface and the outside edges of the profile may be spaced evenly on each side using a piece of wood, foam, or other shimming material. Using the preferred method, any gap present between the bottom of the lower hanging lip of the molding and the top of the working surface may be eliminated by evenly spacing a shim of wood, foam, or a like material behind the working surface to shim it up to the proper height.

e) Once it has been verified that the working surface and molding fit together harmoniously, pilot holes may be drilled through the molding and into the face of the door, in preparation for the wood screws which will hold the entire assembly together. Pilot holes may also be predrilled and counter sunk while the frame is off the door. The pilot holes should be evenly spaced around the molding to ensure the molding will fit tightly against the surface of the door and to improve the aesthetic properties of the door assembly. Using the preferred method, the holes will also be countersunk so the screws fit flush with the surface of the molding.

f) In the preferred embodiment, the molding may be secured onto the face of the door using 1 inch long, #6, flat head, Phillips drive wood screws, for example. In the preferred embodiment, the screws should be countersunk so they lie flush with the molding.

5. Any remaining detail work may then be done on the door (e.g., installing louvers, glass, etc.), and the door can be packaged and shipped to the customer.

An alternate method may entail prefinishing a door slab and then routing the inset groove opening, however, this method would require extra care to avoid damaging or scratching the finished surface of the door.

In another alternative method, the entire door face may consist of having a working surface or surfaces on one or both sides of the door. If both sides of the door include working surfaces, the surfaces may be the same or different from each other.

The door having a working surface may then be installed using conventional door installation techniques at the customer's desired location. The end user may then use these working surfaces as they were intended for use. For example, markerboards or chalkboards may be written on, pins or tacks may be used to hold materials to pushpin boards or corkboards, mirrors may be used to reflect an image, etc. When the time comes for the customer to replace the working surface, they may easily do so by:

a) Removing all wood screws from the perimeter of the molding.

b) Removing the molding from the face of the door

c) Removing the working surface from the recessed area or from the face of the door. It may be necessary to use a piece of thin wire and slip it behind and down the length of the working surface, if any sort of caulking or mirror mastic was required to hold the working surface in place.

d) Placing the new working surface in the opening.

e) Replacing the frame around the working surface and re-install the wood screws.

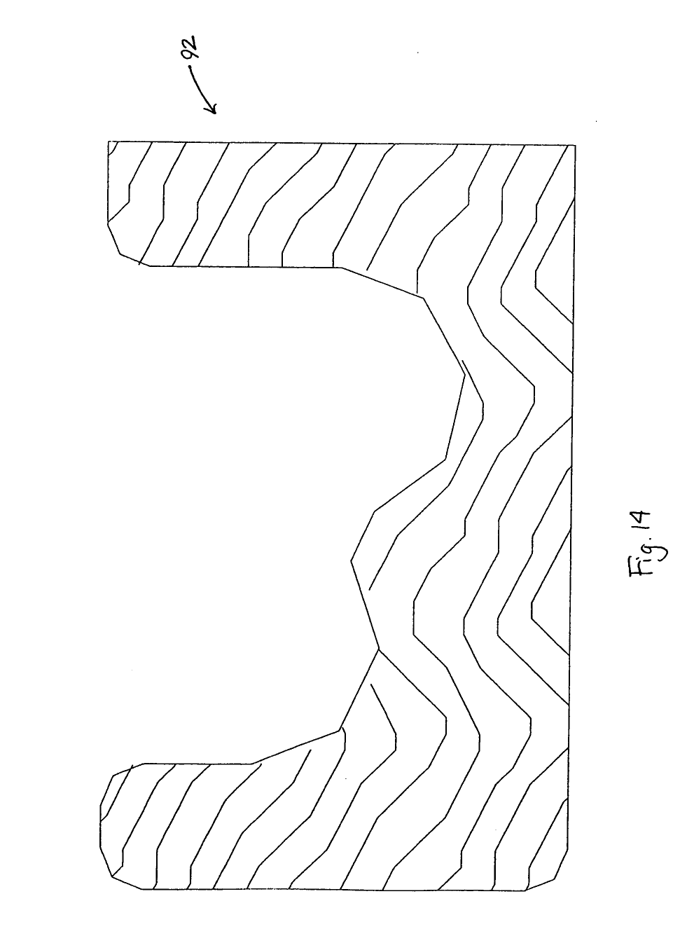

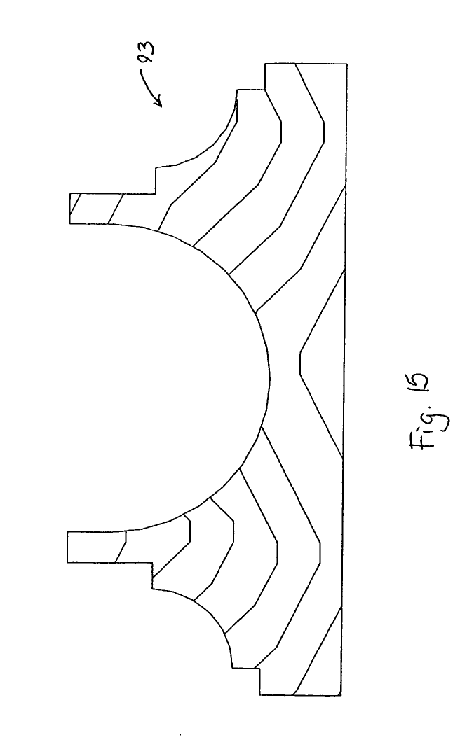

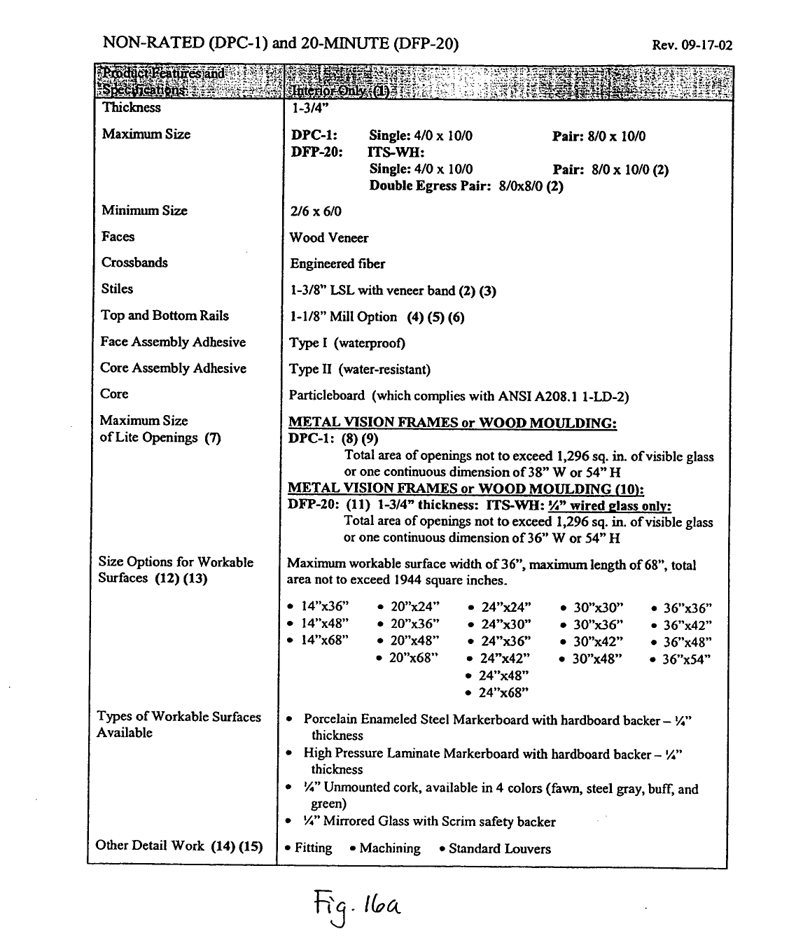

The door of the present invention may also optionally include a tray, holder, or lip secured along at least one of the edges of the working surface for holding markers, chalk, erasers, or other small objects. Examples of such arrangements are shown as assemblies 90 and 95 in FIGS. 13a and 13b, along with example cross-sections for the trays or holders 91 and 96, respectively. Optional cross-sectional views of alternative trays 92 and 93 are shown in FIGS. 14 and 15, respectively however, a wide variety of tray designs could be offered, depending on the user's preferences.

What is claimed is:

1. A method of providing a customer with a vehicle to communicate in an aesthetically and functionally appealing manner, the method comprising at least the step of providing a product line of doors having at least one working surface and at least one customer-selectable option, wherein the at least one option includes a feature of one of the working surfaces.

2. A method of providing a product line comprising a plurality of doors, wherein each door comprises at least one working surface, the method comprising the steps of:
(a) providing a product line of doors having at least one customer-selectable option, wherein the at least one option includes a feature of one of the working surfaces; and
(b) receiving an order comprising a selection of at least one door of the product line of doors, wherein the order includes selection of at least one door and a selection of at least one option for the working surface.

3. The method of claim 2, further comprising the step of manufacturing the at least one door after receiving the order.

4. The method of claim 2, wherein the at least one option includes a set of available sizes for the working surface.

5. The method of claim 2, wherein the at least one option includes a set of available surface materials for the working surface.

6. The method of claim 2, wherein the at least one option allows a customer to specify and design at least one of the shape and size of the working surface.

7. The method of claim 2, wherein the at least one option includes a set of available mounting configurations for the working surface.

8. The method of claim 2, wherein the at least one option includes a set of available mounting configurations for the working surface.

9. The method of claim 2, further comprising the step of making marketing information available to customers, wherein the marketing information comprises a set of available working surface options.

10. A product line of doors comprising a set of doors and a cooperative set of working surface panels, wherein each door has a surface for receiving at least one of the panels of the set of working surface panels.

11. A method of marketing a product line comprising a plurality of doors having at least one working surface, the method comprising the steps of:
(a) providing a product line of doors to a customer, wherein the product line includes at least one working surface panel and at least one door;
(b) receiving an order comprising a selection of at least one door of the product line of doors, wherein the order includes a selection of at least one working surface panel.

12. A product line comprising a plurality of doors, each door fitted with one or more working surfaces, the working surfaces being available in multiple configurations such that a customer has an option of selecting at least one door of the product line with a desired working surface configuration.

13. A method, comprising the step of marketing the product line of claim 11.
